(19) United States
(12) Patent Application Publication
(10) Pub. No.: US 2025/0383831 A1
(43) Pub. Date: Dec. 18, 2025

(54) METHOD, APPARATUS, DEVICE, AND STORAGE MEDIUM FOR DATA TRANSMISSION

(71) Applicants: Guangzhou Shiyuan Electronic Technology Company Limited, Guangzhou (CN); Guangzhou Shiyuan Innovation Technology Co., Ltd., Guangzhou (CN)

(72) Inventor: Xiang LI, Guangzhou (CN)

(73) Assignees: Guangzhou Shiyuan Electronic Technology Company Limited, Guangzhou (CN); Guangzhou Shiyuan Innovation Technology Co., Ltd., Guangzhou (CN)

(21) Appl. No.: 19/285,317

(22) Filed: Jul. 30, 2025

Related U.S. Application Data
(63) Continuation of application No. PCT/CN2025/076570, filed on Feb. 8, 2025.

(30) Foreign Application Priority Data
Jun. 12, 2024 (CN) 202410754173.6

(51) Int. Cl. G06F 3/14

(52) U.S. Cl. CPC G06F 3/1454

(57) ABSTRACT

The present application discloses a method, apparatus and device for data transmission. The method for data transmission includes receiving a sharing instruction and generating shared data based on the sharing instruction; obtaining first transmission performance information of a main screen device and determining whether relaying is required based on the first transmission performance information of the main screen device; when the relaying is required, transmitting the shared data to an adapted relaying device, such that a target requesting device is capable of receiving the shared data via a relaying operation performed by the adapted relaying device; where the target requesting device is one of the plurality of display devices, and the target requesting device has a sharing requirement; the adapted relaying device is one of the plurality of display devices other than the target requesting device.

### CROSS-REFERENCE TO RELATED APPLICATIONS

This application is a continuation of International Application No. PCT/CN2025/076570 filed on Feb. 8, 2025, which claims the priority of the Chinese patent application No. 202410754173.6 filed on Jun. 12, 2024, entitled with “Method, Apparatus and Device For Data Transmission”, which is incorporated herein by reference in its entirety.

### TECHNICAL FIELD

The present disclosure relates to the field of screen mirroring technology, and particularly relates to a method, apparatus and device for data transmission.

### BACKGROUND

Screen mirroring refers to a transmitting device transmitting first multimedia resource played by itself to a target requesting device, such that the first multimedia resource may be played on the target requesting device. Reverse screen mirroring refers to transmitting second multimedia resource played by the target requesting device to a transmitting device, such that the second multimedia resource may be played on the transmitting device.

In a speech scene, a speaker's terminal device establishes a transmission channel with a large screen. The speaker may display the speech contents on the large screen by operating the terminal device, and audiences may watch the large screen to understand the speech contents. Some speakers (or audiences) in the back row are far away from the large screen, and it is not easy to see the speech contents displayed on the large screen. Therefore, in the related technology, the speech contents displayed on the large screen is often reversely projected to the terminal devices of the audiences in the back row.

However, the number of terminal devices that support simultaneous reverse screen mirroring of the large screen in the related technology is limited, and it is not suitable for situations where there is a large demand for reverse screen mirroring.

### SUMMARY

The purpose of the embodiments of the present application is to provide method, apparatus and device, and storage medium for data transmission, which may solve the problem in the related art that the number of terminal devices that support simultaneous reverse screen mirroring of large screens is limited and is not suitable for situations where there is a large demand for reverse screen mirroring.

To achieve the above purpose, according to a first aspect of the present application, a method for data transmission used in a main screen device is provided, where data can be mutually transmitted between the main screen device and a plurality of display devices, as well as among the plurality of display devices through a Personal Area Network (PAN) or a Local Area Network (LAN), and the method includes: receiving a sharing instruction and generating shared data based on the sharing instruction; obtaining first transmission performance information of the main screen device and determining whether relaying is required based on the first transmission performance information of the main screen device; when the relaying is required, transmitting the shared data to an adapted relaying device, such that a target requesting device is capable of receiving the shared data via a relaying operation performed by the adapted relaying device; where the target requesting device is one of the plurality of display devices, and the target requesting device has a sharing requirement; the adapted relaying device is one of the plurality of display devices other than the target requesting device.

Alternatively, the first transmission performance information includes current load capacity and standard load capacity of the main screen device; the current load capacity indicates the amount of the shared data currently being transmitted by the main screen device; the obtaining of the first transmission performance information of the main screen device and determining whether relaying is required based on the first transmission performance information of the main screen device includes: obtaining the current load capacity and the standard load capacity of the main screen device; when the current load capacity is less than the standard load capacity, determining that relaying is not required; when the current load capacity is equal to the standard load capacity, determining that relaying is required.

Alternatively, the method for data transmission further includes: obtaining second transmission performance information transmitted by at least one candidate relaying device, and selecting the adapted relaying device from the at least one candidate relaying device based on the second transmission performance information transmitted by the at least one candidate relaying device; the candidate relaying device is one of the plurality of display devices other than the target requesting device, and the candidate relaying device meets one of the following two conditions: a display device with sharing requirements and capable of transmitting at least one set of shared data, and a display device without sharing requirements and supporting simultaneous transmission of multiple sets of shared data.

Alternatively, the at least one candidate relaying device forms single layer or multiple layers; when the at least one candidate relaying device forms multiple layers, all the candidate relaying devices in the first layer directly receive the shared data transmitted by the main screen device, and the candidate relaying devices in an upper layer transmit the shared data to corresponding candidate relaying devices in an adjacent lower layer; the selecting of the adapted relaying device from the at least one candidate relaying device based on the second transmission performance information transmitted by the at least one candidate relaying device includes traversing each layer of the at least one candidate relaying device in hierarchical order based on the second transmission performance information transmitted by the at least one candidate relaying device, until the adapted relaying device is selected.

Alternatively, the traversing each layer of the at least one candidate relaying device in hierarchical order based on the second transmission performance information transmitted by the at least one candidate relaying device includes: determining relaying priorities of the candidate relaying devices in the same layer based on the second transmission performance information transmitted by the at least one candidate relaying device; selecting the candidate relaying device having the highest relaying priority, among the candidate relaying devices in the same layer, as the adapted relaying device.

Alternatively, the second transmission performance information includes at least one of the gateway information, relayed amount, and remaining relaying amount of the candidate relaying device; where the relayed amount indicates the amount of the shared data currently relayed by the candidate relaying device; and the remaining relaying amount indicates the amount of the shared data that the candidate relaying device can continue relaying.

Alternatively, when determining the relaying priorities based on the gateway information, the relaying priority of the candidate relaying device in the same LAN as the target requesting device is higher than the relaying priority of the candidate relaying device in a different LAN from the target requesting device; and/or, when determining the relaying priorities based on the relayed amount, the relaying priority of the candidate relaying device having the relayed amount of zero is higher than the relaying priority of the candidate relaying device having the relayed amount greater than zero; and/or, when determining the relaying priorities based on the remaining relaying amount, the relaying priority of the candidate relaying device having a larger remaining relaying amount is higher than the relaying priority of the candidate relaying device having a smaller remaining relaying amount.

Alternatively, a notification message is transmitted to the target requesting device, and the notification information is for enabling the target requesting device to establish a transmission channel with the adapted relaying device, such that the adapted relaying device forwards the shared data to the target requesting device through the transmission channel.

Alternatively, the method for data transmission further includes: when the transmission channel between the target requesting device and the adapted relaying device is disconnected, obtaining a new sharing instruction, and generating new shared data based on the new sharing instruction; obtaining new first transmission performance information of the main screen device, and determining whether relaying is required based on the new first transmission performance information of the main screen device; when the relaying is required, transmitting the new sharing instruction to the new adapted relaying device, such that the target requesting device is capable of receiving the new shared data via a relaying operation performed by the new adapted relaying device.

To achieve the above purpose, according to a second aspect of the present application, a method for data transmission used in a target requesting device is provided, wherein the target requesting device is one of a plurality of display devices, and data can be mutually transmitted between a main screen device and a plurality of display devices, as well as among the plurality of display devices through a Personal Area Network (PAN) or a Local Area Network (LAN); the method includes: transmitting a sharing instruction to the main screen device; the sharing instruction is for enabling the main screen device to generate shared data and transmit the shared data or select an adapted relaying device to forward the shared data; where the adapted relaying device is one of the plurality of display devices other than the target requesting device.

Alternatively, the method for data transmission further includes: receiving notification information transmitted by the main screen device when selecting an adapted relaying device to forward the shared data; establishing a transmission channel with the adapted relaying device based on the notification information, and receiving the shared data relayed by the adapted relaying device through the transmission channel.

To achieve the above purpose, according to a third aspect of the present application, an apparatus for data transmission used in a main screen device is provided, where data can be mutually transmitted between a main screen device and a plurality of display devices, as well as among the plurality of display devices through a Personal Area Network (PAN) or a Local Area Network (LAN), and the apparatus includes: a first obtaining module configured to receive a sharing instruction and generate shared data based on the sharing instruction; a second obtaining module configured to obtain first transmission performance information of the main screen device, and determine whether relaying is required based on the first transmission performance information of the main screen device; a processing module configured to transmit shared data to an adapted relaying device when the relaying is required, such that the target requesting device is capable of receiving the shared data via a relaying operation performed by the adapted relaying device; the target requesting device is one of the plurality of display devices; the adapted relaying device is one of the plurality of display devices other than the target requesting device.

To achieve the above purpose, according to a fourth aspect of the present application, an electronic device is provided, which includes a processor, a memory and a computer program stored on the memory and executable by the processor, where the computer program, when executed by the processor, causes the electronic device to perform the above methods.

To achieve the above purpose, according to a fifth aspect of the present application, a computer-readable storage medium storing a computer program is provided, where the computer program, when executed by a processor, causes the above methods to be performed.

In summary, the method for data transmission, apparatus, device and storage medium provided by the embodiments of the present application determines whether the main screen device may still transmit shared data to the target requesting device based on the first transmitting performance information of the main screen device, that is, whether relaying is required. If the relaying is not required, the main screen device directly transmits the shared data to the target requesting device; if the relaying is required, the main screen device transmits the shared data to the adapted relaying device, and then the adapted relaying device forwards the shared data to the target requesting device. As such, when there is a large demand for sharing, the shared data is relayed by using the adapted relaying device, which has an advantage of sharing the transmitting pressure of the main screen device.

### BRIEF DESCRIPTION OF THE DRAWINGS

In order to more clearly describe the technical solutions of the embodiments of the present application, a brief introduction to the accompanying drawings required in the description of the embodiments is provided below. It is obvious that the accompanying drawings described below are merely some embodiments of the present application. For those skilled in the art, other accompanying drawings can be obtained based on these drawings without making creative efforts.

FIG. 1 is a schematic diagram of a scene according to an embodiment of the present application;

FIG. 2 is an interactive signaling diagram according to an embodiment of the present application;

FIG. 3 is a schematic diagram according to an embodiment of the present application;

FIG. 4 is a schematic diagram of an apparatus for data transmission according to an embodiment of the present application;

FIG. 5 is a structural diagram of an electronic device according to an embodiment of the present application.

### DESCRIPTION OF THE PREFERRED EMBODIMENTS

As described in the BACKGROUND, the large screen in the related technology has the problem that the number of terminal devices that support simultaneous reverse screen mirroring is limited, and it is not suitable for situations where there is a large demand for reverse screen mirroring. The inventor has found the reason for this problem lies in: under the same LAN, due to the limitations of the performance of the large screen, network, and IO performance, it may support reverse screen mirroring to 4-6 terminal devices at most at the same time, that is, the large screen may transmit shared data to 4-6 terminal devices at most. If there are more, various abnormal situations such as content jamming and disconnection would occur.

For the above technical problems, the inventors of this application tried to adopt a wide area network live broadcast solution. However, this solution has problems such as insufficient clarity, serious picture delay, extremely high cost, high design complexity, and difficulty in implementation. Therefore, the inventors tried to continue to seek solutions for solving the above problems in the LAN. Considering that there are a plurality of terminal devices in the speech scene, and these terminal devices all have the ability for receiving and transmitting data. Based on that, one or several terminal devices may be used as a relaying station to receive shared data from the large screen and transmit the shared data to multiple other terminal devices at the same time. In this way, the transmitting pressure of the large screen may be shared, which is suitable for situations where there is a large demands for reverse screen mirroring.

In order to make the purpose, technical solutions and advantages of the embodiments of the present application clearer, the technical solutions in the embodiments of the present application would be clearly and completely described in conjunction with the drawings in the embodiments of the present application, it is obvious that the described embodiments are part of the embodiments of the present application, rather than all the embodiments.

Based on the embodiments in the present application, all other embodiments obtained by those skilled in the art without creative works fall within the protection scope of the present application. In the absence of conflict, the following embodiments and features described in the embodiments may be combined with each other.

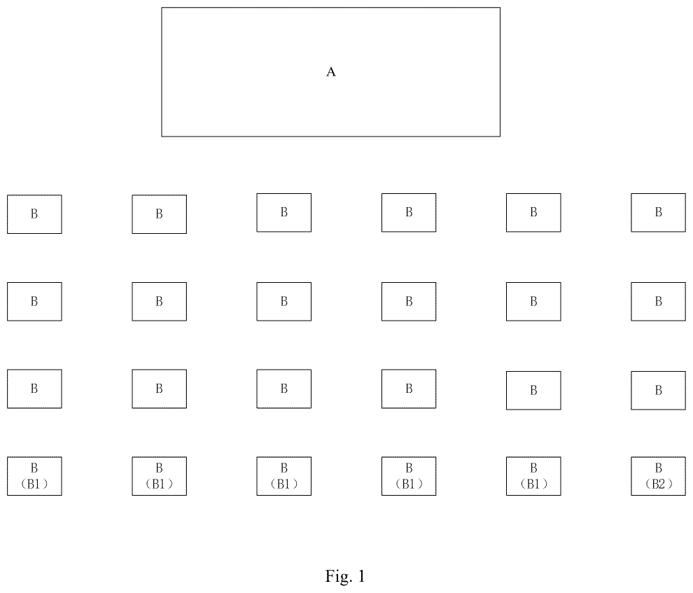

FIG. 1 is a schematic diagram of a speech scene according to the embodiment of the present application. Referring to FIG. 1, the speech scene provided by the embodiment of the present application may include a main screen device A and a plurality of display devices B. The main screen device A and the display device B may be terminal devices or portable terminal devices having display screens such as mobile phones, wearable devices, tablet computers, personal digital assistants (PDA), laptops, mobile computers, interactive boards, and so on. Data may be transmitted between the main screen device A and the plurality of display devices B, and between the plurality of display devices B through PAN or LAN. In other words, each display device B among the plurality of display devices B may transmit data to the main screen device A through PAN or LAN, and any two display devices B among the plurality of display devices B may also transmit data to each other through PAN or LAN. It may achieve PAN with point-to-point communication through technologies such as Bluetooth technology and IrDA infrared connection technology. It may achieved LAN with multi-terminal communication through WiFi. The PAN and LAN may also be achieved through a data cable.

In an example of a speech scene, the main screen device A may be a large-sized interactive board, which may be placed in front of the venue for multiple people to watch; the display device B may be a computer or a mobile phone. The speech scene may include meeting scenes, teaching scenes, product promotion scenes, stage performance scenes, and so on. In other words, A scene where multiple people participate in an event at one venue and one or several of them can use the main screen device A to display media contents to the rest of the participants may be classified as the speech scene.

In one of the generalized speech scenes, a participant may project the media contents displayed on the display device B beside him/her to the main screen device A through a hardware screen projector, screen mirroring software, a data cable, and so on, or a participant directly controls the main screen device A to display the media contents, and the other participants may choose to directly watch the media contents displayed on the main screen device A, or the other participants may choose to display the media contents through the display device B beside them. The method for data transmission provided in the embodiment of the present application is intended to solve the situation when multiple participants all require to use the display device B beside them to display the media contents. In another generalized speech scene, a participant transmits the file stored in the memory of the main screen device A to the display device B of the other participants. At this time, the method for data transmission provided in the embodiment of the present application is intended to solve the situation when multiple participants all require to use the display device B beside them to receive the file.

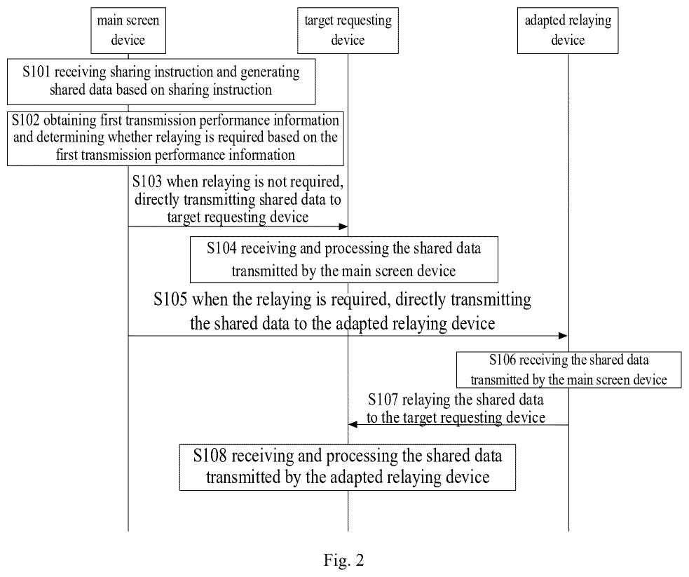

FIG. 2 is an interactive signaling diagram according to an embodiment of the present application. Referring to FIG. 2, the method for data transmission provided by an embodiment of the present application is described from the perspective of the interaction between the target requesting device, the main screen device, and the adapted relaying device.

Referring to FIG. 2, the method for data transmission provided by an embodiment of the present application may include the following steps:

S101, the main screen device obtains a sharing instruction and generates shared data based on the sharing instruction.

The target requesting device may be one of a plurality of display devices, and the target requesting device is a device having a sharing requirement. The sharing instruction may include identification information related to the target requesting device (such as an IP address, etc.) such that the main screen device may transmit the shared data in a targeted manner. For example, the sharing instruction may be triggered by a user through an input device. The input device may be a keyboard, a mouse, a voice module, a touch screen, and so on. For example, a participant with a sharing requirement may inform an operator of the main screen device about the identification number of the display device (i.e., the target requesting device) beside him/her, and the operator of the main screen device may input the identification number through the input device, or the operator of the main screen device may select the identification corresponding to the target requesting device on the main screen device to generate a sharing instruction. For another example, the sharing instruction may be transmitted by the target requesting device to the main screen device. For example, a participant with sharing needs may input a request sharing command to the display device (i.e., the target requesting device) beside him/her. The request sharing command may enable the target requesting device to generate a sharing instruction and transmit the sharing instruction to the main screen device.

The shared data may be encoded with the contents being displayed on the main screen device; or, the shared data may be encoded with a file stored in the memory of the main screen device that needs to be shared. The shared data may be audio, video, audio and video, text, and so on.

S102, the main screen device obtains the first transmitting performance information, and determines whether relaying is required based on the first transmission performance information of the main screen device.

After the main screen device obtains the sharing instruction, the main screen device needs to transmit the shared data to the corresponding target requesting device. When the main screen device obtains multiple different sharing instructions, the main screen device needs to transmit multiple shared data to multiple target requesting devices one by one. However, since the performance of the main screen device is limited, the main screen device with poor performance can only transmit shared data to one device, and the main screen device with good performance may transmit shared data to multiple devices at the same time. When the number of target requesting devices exceeds the number of shared data allowed to be transmitted by the main screen device, an adapted relaying device may be used for relaying to reduce the pressure on the main screen device. For example, if the number of target requesting devices is 15, and the number of shared data allowed to be transmitted by the main screen device is 6, since 15 is greater than 6, an adapted relaying device is required for relaying.

The main screen device may determine the number of target requesting devices based on the number of sharing instructions obtained, but when some a target requesting device exits, the number of sharing instructions remains unchanged. In this way, there is a lag in determining whether relaying is required based on the number of obtained sharing instructions. Based on that, it may determine whether relaying is required by determining whether the current load capacity of the main screen device reaches the standard load capacity.

In step S102, the first transmitting performance information may include current load capacity and standard load capacity. The current load capacity may indicate the number of shared data currently being transmitted by the main screen device. The standard load capacity may be a fixed value; or, the standard load capacity may vary with the variation of the maximum load capacity of the main screen device. The maximum load capacity may indicate the maximum number of shared data that the main screen device may currently transmit simultaneously, which may be calculated based on the performance of the main screen device itself (such as CPU occupancy, memory occupancy, CPU main frequency, etc.). The standard load capacity may be less than the maximum load capacity; or, the standard load capacity may be equal to the maximum load capacity; or, the standard load capacity may be greater than the maximum load capacity by one amount. When the standard load capacity is less than or equal to the maximum load capacity, the main screen device may smoothly display the media contents.

In step S102, when the current load capacity is less than the standard load capacity, it may be determined that relaying is not required; when the current load capacity is equal to the standard load capacity, it may be determined that relaying is required. For example, the standard load capacity is 4, if the current load capacity is 3, it is determined that relaying is not required; if the current load capacity is 4, it is determined that relaying is required.

S103, when the relaying is not required, the main screen device transmits shared data to the target requesting device. For example, when the relaying is not required, it indicates that the main screen device has the ability of undertaking the task of transmitting shared data, so the main screen device may transmit the shared data to the target requesting device.

S104, the target requesting device may receive and process the shared data transmitted by the main screen device.

The shared data is an encoded data stream, so the target requesting device first decodes the shared data, and then performs targeted processing based on respective types of shared data. For example, when the shared data is encoded with the contents being displayed on the main screen device, the image data in the decoded shared data may be rendered and displayed on the display screen of the target requesting device; and/or, the audio data in the decoded shared data may be played through the target requesting device. When the shared data is encoded with a file stored in the memory of the main screen device that needs to be shared, the decoded shared data may be stored in the storage location of the target requesting device specified by the user.

S105, when the relaying is required, the main screen device transmits the shared data to the adapted relaying device. S106, the adapted relaying device receives the shared data transmitted by the main screen device. S107, the adapted relaying device transmits the shared data to the target requesting device. S108, the target requesting device receives and processes the shared data transmitted by the adapted relaying device. In this way, when the relaying is required, the shared data is relayed by the adapted relaying device so as to share the transmitting pressure of the main screen device.

The adapted relaying device may be one of the plurality of display devices other than the target requesting device. The adapted relaying device may have two following usages. The first usage is: only relaying shared data; the second usage is: both processing shared data as a request device and relaying shared data to other request devices. When the adapted relaying device is used for the first usage, the adapted relaying device receives shared data in S106 and S107 and forwards shared data to the target requesting device. When the adapted relaying device is used for the second usage, the adapted relaying device receives shared data and forwards shared data to the target requesting device, and also processes shared data in S106 and S107. In addition, how the target requesting device processes shared data in step S108 may refer to step S104, which is not repeated here.

Alternatively, the adapted relaying device may be selected by the main screen device from at least one candidate relaying device. Alternatively, the method for data transmission provided in the embodiment of the present application may also include the following steps.

S201, at least one candidate relaying device may transmit second transmission performance information to the main screen device. S202, when the relaying is required, the main screen device may receive the second transmission performance information transmitted by at least one candidate relaying device; and select an adapted relaying device from at least one candidate relaying device based on the second transmission performance information.

Referring to FIG. 1, the candidate relaying device B1 may be one of the plurality of display devices B other than the target requesting device B2. Alternatively, one of the plurality of display devices B may be used as the target requesting device B2, and another of the plurality of display devices B may be used as the candidate relaying device B1. The display device B that is the target requesting device B2 cannot be used as its own candidate relaying device B1. Additionally, there may be a display device B that may be used as the request device B2, and may also be used as the candidate relaying device B1 of other request devices B2.

In addition, the candidate relaying device may meet one of the following two conditions: The first condition: a display device that has a sharing requirement and transmits at least one set of shared data, so as to simultaneously perform the processing and relaying of the shared data, so as to maximize the use of the candidate relaying device. The second condition: a display device that has no sharing requirement and supports transmitting multiple sets of shared data at the same time, so as to forward the shared data to more target requesting devices.

In step S201, at least one candidate relaying device transmits the second transmission performance information to the main screen device. In other words, each of at least one candidate relaying device may transmit the second transmission performance information to the main screen device.

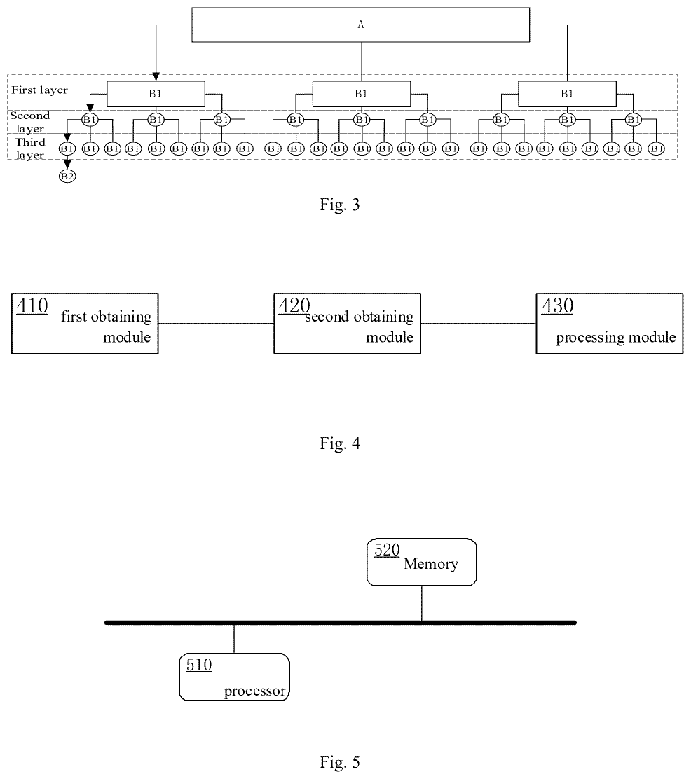

It should be noted that the more candidate relaying devices there are, the more options are available for the adapted relaying device, and the more shared data all the candidate relaying devices forward in total, which is more suitable for situations with more sharing requirements. The preset relaying device needs to establish a transmission channel with the main screen device to achieve communication between them. However, the number of shared data that the main screen device supports to be transmitted simultaneously is limited, so the number of candidate relaying devices that communicate directly with the main screen device is limited. Based on that, referring to FIG. 3, all candidate relaying devices may form a layer structure.

Alternatively, all candidate relaying devices may form single layer or multiple layers. When all candidate relaying devices form one layer, the layer may directly receive the shared data transmitted by the main screen device. When all candidate relaying devices form multiple layers, all candidate relaying devices in the first layer may directly receive the shared data transmitted by the main screen device, and the candidate relaying devices in an upper layer may transmit shared data to the corresponding candidate relaying devices in an adjacent lower layer.

In step S202, selecting an adaptable relaying device from at least one candidate relaying device based on the second transmission performance information transmitted by at least one candidate relaying device may include: traversing each layer of the at least one candidate relaying device in hierarchical order based on the second transmission performance information transmitted by the at least one candidate relaying device, until the adapted relaying device is selected. Alternatively, it first selects the adaptable relaying device from the first layer; if no adaptable relaying device is selected from the first layer, it selects the adaptable relaying device from the second layer; . . . and so on, until an adaptable relaying device is selected.

For example, in FIG. 3, the candidate relaying devices form three layers. The main screen device first selects the adapted relaying device from the first layer. When the remaining relaying amount of all the candidate relaying devices in the first layer is zero, it means that the adapted relaying device cannot be selected from the first layer, and the adapted relaying device would be selected from the second layer. If the remaining relaying amount of all the candidate relaying devices in the second layer is zero, it means that the adapted relaying device cannot be selected from the second layer, and then the adapted relaying device would be selected from the third layer. In FIG. 3, the first candidate relaying device in the third layer is used as an adapted relaying device to transmit shared data to the target requesting device. The process of transmitting shared data is as followed: main screen device→first candidate relaying device in the first layer→first candidate relaying device in the second layer→first candidate relaying device in the third layer→target requesting device.

It should be noted that when the candidate relaying devices form multiple layers, the candidate relaying devices in the first layer may be display devices with sharing requirements and capable of transmitting at least one set of shared data; or display devices without sharing requirements and supporting the simultaneous transmission of multiple sets of shared data. The candidate relaying devices in the remaining layers may all be display devices with sharing requirements and capable of transmitting at least one set of shared data. The main screen device only needs to select the first layer of candidate relaying devices from a plurality of display devices. The candidate relaying devices of the remaining layers may be obtained with the execution of the method for data transmission. In other words, the candidate relaying devices of the remaining layers may be used as their adapted relaying devices by the corresponding candidate relaying devices of the upper layer to transmit shared data. For example, in FIG. 3, during the process of the first candidate relaying device of the third layer receiving shared data, the first candidate relaying device of the second layer may forward the shared data as its adapted relaying device.

The following describes how the main screen device selects an adapted relaying device from the same layer.

Based on the second transmission performance information transmitted by at least one candidate relaying device, the relaying priority of the candidate relaying device in the same layer among at least one candidate relaying device is determined; and the candidate relaying device with the highest relaying priority among the candidate relaying devices in the same layer is used as the adapted relaying device.

The second transmission performance information may include at least one of the gateway information, the relayed amount, and the remaining relaying amount. The gateway information may indicate the website where the candidate device is located; the relayed amount may indicate the amount of shared data currently relayed by the candidate relaying device; and the remaining relaying amount may indicate the amount of shared data currently allowed to be relayed by the candidate relaying device.

When determining relaying priorities based on the gateway information, the relaying priority of the candidate relaying device in the same LAN as the target requesting device is higher than the relaying priority of the candidate relaying device in a different LAN from the target requesting device. Alternatively, when the target requesting device, the main screen device, and the adapted relaying device are in the same LAN, if relaying is required, the main screen device and the adapted relaying device, and the adapted relaying device and the target requesting device may quickly transmit shared data through the LAN.

When the target requesting device and the adapted relaying device are in different LANs, the target requesting device or the adapted relaying device needs to change the network connection such that the target requesting device and the adapted relaying device are in the same LAN. Alternatively, the target requesting device and the adapted relaying device may form PAN through pairing, connection, and other operations, and transmit shared data through PAN. Therefore, the candidate relaying device in the same LAN as the target requesting device is preferably selected as the adapted relaying device, which has the advantages of facilitating shared data transmission and user convenience.

When determining relaying priorities based on the relayed amount, the relaying priority of the candidate relaying device with a relayed amount of zero is higher than the relaying priority of the candidate relaying device with a relayed amount greater than zero. In this way, the candidate relaying device that has not performed relaying is preferentially selected as the adapted relaying device to reduce the pressure of the device that has performed relaying, such that the shared data may be transmitted more stably.

When determining relaying priorities based on the remaining relaying amount, the relaying priority of the candidate relaying device with a larger remaining relaying amount is higher than the relaying priority of the candidate relaying device with a smaller remaining relaying amount. Alternatively, the larger the remaining relaying amount is, the better the performance of the current candidate relaying device is, and the more suitable it is for relaying shared data, and thus the shared data may be transmitted more stably and faster. Therefore, the candidate relaying device with a large remaining relaying amount is preferentially selected as the adapted relaying device, such that the shared data may be transmitted more stably and faster.

In an exemplary manner, the second transmission performance information may include one of the gateway information, the relayed amount, and the remaining relaying amount, and the main screen device may determine the relaying priority based on that information. For example, the second transmission performance information is the gateway information. In FIG. 1, the first five display devices on the left of the fourth row may all be the candidate relaying devices B1 of the target requesting device B2. The first four preset relaying devices from the left are all in the same LAN as the target requesting device, and the fifth candidate relaying device is not in the same LAN as the target requesting device. Then, the relaying priority of the first four preset relaying devices from the left is higher, and the main screen device may randomly determine a candidate relaying device from the first four preset relaying devices from the left as the adapted relaying device.

In another exemplary embodiment, the second transmitting performance information may include any two of the gateway information, the relayed amount, and the remaining relaying amount, and the main screen device may determine the relaying priority based on the two information in sequence. For example, the second transmitting performance information may include gateway information and the relayed amount, and the relaying priority may be determined first based on the gateway information, and then the relaying priority may be updated based on the relayed amount. In FIG. 1, based on the gateway information, the relaying priorities of the first four candidate relaying devices from the left are determined before the relaying priority of the fifth candidate relaying device from the left. Among the first four candidate relaying devices from the left, the relayed amount of the first three from the left is greater than zero, and the relayed amount of the fourth from the left is zero. Then the relaying priority of the fourth from the left is greater than the relaying priority of the first three from the left, so the fourth candidate relaying device from the left may be used as an adapted relaying device.

In another exemplary embodiment, the second transmission performance information may include gateway information, relayed amount, and remaining relaying amount, and the main screen device may determine the relaying priority based on the three information in an order. Further, the relaying priority may be determined based on the order of gateway information, relayed amount, and remaining relaying amount, so as to take the candidate relaying device having best performance as the adapted relaying device. Alternatively, based on the gateway information transmitted by at least one candidate relaying device, it may find out the candidate relaying device in the same LAN as the target requesting device from at least one candidate relaying device, and the candidate relaying device in the same LAN as the target requesting device may be used as the standby relaying device; when the number of the standby relaying device is one, the relaying priority of the standby relaying device is highest, and the standby relaying device is used as the adapted relaying device.

When there are multiple standby relaying devices, based on the relayed amount transmitted by multiple standby relaying devices, it may find out the standby relaying device with a relayed amount of zero, and the relaying priority of the standby relaying device with a relayed amount of zero is highest, and the standby relaying device with a relayed amount of zero is used as the adapted relaying device.

When the relayed capacities of multiple standby relaying devices are not zero, it may find out the standby relaying device with the largest remaining relaying amount based on the remaining relaying capacities transmitted by the multiple standby relaying devices. The relaying priority of the standby relaying device with the largest remaining relaying amount is highest, and the standby relaying device with the largest remaining relaying amount is used as the adapted relaying device.

For example, in FIG. 1, based on the gateway information, the relaying priorities of the first four candidate relaying devices on the left are determined to be higher than the relaying priority of the fifth candidate relaying device on the left; based on the relayed amount, the relayed capacities of the first four candidate relaying devices on the left are all greater than zero; based on the remaining relaying amount, the remaining relaying amount of the first candidate relaying device on the left is the largest, then the relaying priority of the first candidate relaying device on the left is highest, and the first candidate relaying device on the left is used as the adapted relaying device.

It should be noted that when multiple candidate relaying devices have the same priority, it may randomly select one from the candidate relaying devices having the same priority as the adapted relaying device.

It should be noted that after the main screen device selects the adapted relaying device, it needs to establish a transmission channel between the requesting device and the adapted relaying device. The following describes the method of establishing a transmission channel between them.

S301, the main screen device transmits notification information to the target requesting device. S302, the target requesting device receives the notification information transmitted by the main screen device, and establishes a transmission channel with the adapted relaying device based on the notification information.

Alternatively, the main screen device may inform the target requesting device through the notification information that the shared data would be relayed by the adapted relaying device. The target requesting device may obtain relevant information of the adapted relaying device through the notification information, such that the target requesting device may establish a transmission channel with the adapted relaying device.

Alternatively, before establishing a transmission channel, the target requesting device needs to first verify whether a transmission channel may be established between the target requesting device and the adapted relaying device. For example, if the adapted relaying device and the target requesting device are not in the same LAN, the target requesting device networking information needs to be changed to be consistent with that of the relaying device; or, the target requesting device needs to be paired with the adapted relaying device to form a point-to-point PAN. If the user of the target requesting device does not intend to change the networking information, or the user of the target requesting device does not intend to pair with the adapter relaying server, a transmission channel cannot be established between the target requesting device and the adapted relaying device.

Alternatively, when the transmission channel cannot be established between the target requesting device and the adapted relaying device, and when the adapted relaying device exits halfway, the target requesting device may transmit a new sharing instruction to the main screen device, or the user of the target requesting device may inform the user of the main screen device, and the user of the main screen device may input a new sharing instruction to the main screen device. The main screen device may obtain the new sharing instruction and generate new shared data based on the new sharing instruction. The main screen device may also obtain new first transmission performance information, and determine whether relaying is required based on the new first transmission performance information of the main screen device. When the relaying is required, the main screen device may transmit shared data to the new adapted relaying device.

In other words, when the transmission channel cannot be established between the target requesting device and the adapted relaying device, and when the adapted relaying device exits halfway, steps S101 to S108, steps S201, S202, S301, and S302 are repeatedly performed. In step 202, the main screen device needs to select a new adapted relaying device from the candidate relaying device excluding the original adapted relaying device. The original adapted relaying device refers to the adapted relaying device selected by the main screen device for the target requesting device one or more times before this time.

When the adapted relaying device exits halfway, in order to avoid losing shared data, the following operations may be performed. When the shared data is encoded with the contents being displayed on the main screen device, the target requesting device may directly request a key frame to process the new data. When the shared data is encoded with a file stored in the memory of the main screen device that needs to be shared, the target requesting device may specify the file range (or position) to be retransmitted to the new adapted relaying device or the main screen device.

It should be understood that each step of the above method may be performed by the hardware integrated logic circuit in the processor or the instruction in the form of software. The steps of the method disclosed in the embodiments of the present application may be directly performed by the hardware processor, or by the combination of hardware and software modules in the processor. The software module may be located in a mature storage medium in the field, such as random access memory, flash memory, read-only memory, programmable read-only memory or electrically erasable programmable memory, register, and so on. The storage medium is located in the memory, and the processor reads the information in the memory and performs the steps of the above method in combination with its hardware. To avoid repetition, it is not described in detail here.

Referring to FIG. 4, the embodiment of the present application also provides an apparatus for data transmission, which may include a first obtaining module 410, a second obtaining module 420 and a processing module 430. The first obtaining module 410 may be configured to receive a sharing instruction and generate shared data based on the sharing instruction. The second obtaining module 420 may be configured to obtain the first transmission performance information of the main screen device, and determine whether relaying is required based on the first transmission performance information of the main screen device. The processing module 430 may transmit shared data to the adapted relaying device when the relaying is required, such that the target requesting device is capable of receiving the shared data via a relaying operation performed by the adapted relaying device. The target requesting device is one of the plurality of display devices; the candidate relaying device is one of the plurality of display devices other than the target requesting device.

Alternatively, the first transmission performance information includes current load capacity and standard load capacity of the main screen device; the current load capacity indicates the number of shared data currently transmitted by the main screen device at the same time. The first obtaining module 410 may obtain the current load capacity and the standard load capacity of the main screen device, and when the current load capacity is less than the standard load capacity, it is determined that the relaying is not required; when the current load capacity is equal to the standard load capacity, it is determined that the relaying is required.

Alternatively, the second obtaining module 420 may also obtain the second transmission performance information transmitted by at least one candidate relaying device, and select the adapted relaying device from at least one candidate relaying device based on the second transmission performance information transmitted by at least one candidate relaying device. The candidate relaying device is one of the plurality of display devices other than the target requesting device, and the candidate relaying device meets one of the following two conditions: a display device with a sharing requirement and capable of transmitting at least one set of shared data, and a display device without a sharing requirement and supporting the simultaneous transmission of multiple sets of shared data.

Alternatively, at least one candidate relaying device form single layer or multiple layers; when at least one candidate relaying device form multiple layers, all candidate relaying devices in the first layer directly receive the shared data transmitted by the main screen device, and the candidate relaying devices in an upper layer may transmit shared data to the corresponding candidate relaying devices in an adjacent lower layer. The second obtaining module 420 may also traverse each layer of at least one candidate relaying device based on the second transmission performance information transmitted by at least one candidate relaying device, until an adapted relaying device is selected.

Alternatively, the second obtaining module 420 may traverse each layer of at least one candidate relaying device based on the second transmission performance information transmitted by at least one candidate relaying device, which may include the followings. The second obtaining module 420 may determine the relaying priority of the candidate relaying device in the same layer of at least one candidate relaying device based on the second transmission performance information transmitted by at least one candidate relaying device; and take the candidate relaying device with the highest relaying priority among the candidate relaying device in the same layer as the adapted relaying device.

Alternatively, the second transmission performance information includes at least one of the gateway information of the candidate relaying device, the relayed amount, and the remaining relaying amount; where the relayed amount indicates the amount of shared data currently relayed by the candidate relaying device; and the remaining relaying amount indicates the amount of the shared data that the candidate relaying device can continue relaying. Alternatively, when the second obtaining module 420 determines the relaying priority based on the gateway information, the relaying priority of the candidate relaying device in the same LAN as the target requesting device is higher than the relaying priority of the candidate relaying device in a different LAN as the target requesting device; and/or, when the second obtaining module 420 determines the relaying priority based on the relayed amount, the relaying priority of the candidate relaying device with a relayed amount of zero is higher than the relaying priority of the candidate relaying device with a relayed amount greater than zero; and/or, when the second obtaining module 420 determines the relaying priority based on the remaining relaying amount, the relaying priority of the candidate relaying device with a larger remaining relaying amount is higher than the relaying priority of the candidate relaying device with a smaller remaining relaying amount.

Alternatively, the processing module 430 may transmit notification information to the target requesting device. The notification information is used to establish a transmission channel between the target requesting device and the adapted relaying device, such that the adapted relaying device forwards the shared data to the target requesting device through the transmission channel.

Alternatively, when the transmission channel between the target requesting device and the adapted relaying device is disconnected, the first obtaining module 410 may obtain a new sharing instruction and generate new shared data based on the new sharing instruction. The second obtaining module 420 may obtain the new first transmission performance information of the main screen device, and determine whether relaying is required based on the new first transmission performance information of the main screen device. The processing module 430 may transmit a new sharing instruction to the new adapted relaying device when the relaying is required, such that the target requesting device may receive new shared data relayed by the new adapted relaying device.

Referring to FIG. 5, the electronic device of this embodiment may include: at least one processor 510; and a memory 520 connected to the at least one processor in communication; where the memory 520 stores instructions executable by the at least one processor 510, and the instructions, when executed by the at least one processor 510, causes the electronic device to perform the method of any of the above embodiments.

Alternatively, the memory 520 may be independent or integrated with the processor 510.

The implementation principle and technical effect of the electronic device provided by this embodiment may be referred to the above embodiments, which is not repeated here. The embodiment of this application also provides a computer-readable storage medium, in which a computer-executable instruction is stored. When the processor executes the computer-executable instruction, the method of any of the above embodiments is performed.

The embodiment of this application also provides a computer program product, which includes a computer program. The computer program, when executed by a processor, causes the method of any of the above embodiments to be performed.

In the several embodiments provided in this application, it should be understood that the disclosed device and method may be implemented in other ways. For example, the device embodiments described above are only illustrative. For example, the division of modules is only a logical function division. There may be other division ways in actual implementation, such as multiple modules may be combined or integrated into another system, or some features may be ignored or not implemented.

The integrated modules implemented in the form of software function modules may be stored in a computer-readable storage medium. The software function modules are stored in a storage medium, including several instructions for a computer device (which may be a personal computer, a server, or a network device, etc.) or a processor to perform some steps of the methods of various embodiments of the present application.

It should be understood that the processor may be a central processing unit (CPU), or other general-purpose processors, digital signal processors (DSP), application-specific integrated circuits (ASIC), and so on. The general-purpose processor may be a microprocessor or the processor may be any conventional processor, and so on. The steps of the method disclosed in the application may be directly embodied as being executed by a hardware processor, or executed by a combination of hardware and software modules in the processor. The memory may include high-speed RAM memory, and may also include non-volatile storage NVM, such as at least one disk memory, and may also be a USB flash drive, a mobile hard disk, a read-only memory, a disk or an optical disk, and so on.

The above storage medium may be implemented by any type of volatile or non-volatile storage device or a combination thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, disk or optical disk. The storage medium may be any available medium that may be accessed by a general or special-purpose computer.

An exemplary storage medium is coupled to a processor such that the processor may read information from the storage medium and write information to the storage medium. The storage medium may also be a component of the processor. The processor and the storage medium may be located in an application specific integrated circuit (ASIC). The processor and the storage medium may also act as discrete components in an electronic device or a main control device.

It should be noted that the terms “include”, “comprises” or any other variants thereof in this disclosure are intended to cover non-exclusive inclusion, such that a process, method, item or device including a series of elements includes not only those elements, but also other elements not explicitly listed, or also includes elements inherent to such process, method, article or device. In the absence of further limitation, an element defined by the sentence “includes one . . . ” does not exclude the existence of other identical elements in the process, method, article or device including the element.

The serial numbers of the embodiments of the present application are only for description and do not limit the advantages and disadvantages of the embodiments.

Through the description of the above implementation methods, those skilled in the art may clearly understand that the above-mentioned methods may be implemented by means of software plus the necessary general hardware platform, as well as by hardware, but in many cases the former is a better implementation. Based on this understanding, the technical solution of the present application is essentially or the part that contributes to the prior art may be embodied in the form of a software product, which is stored in a storage medium (such as ROM/RAM, disk, CD), and includes several instructions for a terminal device (which may be a mobile phone, computer, server, air conditioner, or network device, etc.) to execute the methods of each embodiment of the present application.

The above are only some embodiments of this application, and do not limit the scope of this application. Any equivalent structure or equivalent process modification made using the contents of the description and drawings of this application, or directly or indirectly applied in other related technical fields, are also fell with the protection scope of this application.

What is claimed is:

1. A method for data transmission used in a main screen device, wherein data can be mutually transmitted between the main screen device and a plurality of display devices, as well as among the plurality of display devices through a Personal Area Network (PAN) or a Local Area Network (LAN), the method comprising:
receiving a sharing instruction and generating shared data based on the sharing instruction;
obtaining first transmission performance information of the main screen device and determining whether relaying is required based on the first transmission performance information of the main screen device; and
in response to determining that relaying is required, transmitting the shared data to an adapted relaying device, such that a target requesting device is capable of receiving the shared data via a relaying operation performed by the adapted relaying device,
wherein the target requesting device is one of the plurality of display devices, which is associated with a sharing requirement; the adapted relaying device is one of the plurality of display devices other than the target requesting device.

2. The method of claim 1, wherein the first transmission performance information includes current load capacity and standard load capacity of the main screen device; the current load capacity indicates amount of the shared data currently being transmitted by the main screen device;
the obtaining of the first transmission performance information of the main screen device and determining whether relaying is required based on the first transmission performance information of the main screen device comprise:
obtaining the current load capacity and the standard load capacity of the main screen device;
in response to determining that the current load capacity is less than the standard load capacity, determining that relaying is not required; and
in response to determining that the current load capacity is equal to the standard load capacity, determining that relaying is required.

3. The method of claim 1, further comprising:
obtaining second transmission performance information transmitted by at least one candidate relaying device, and selecting the adapted relaying device from the at least one candidate relaying device based on the second transmission performance information transmitted by the at least one candidate relaying device;
wherein the candidate relaying device is one of the plurality of display devices other than the target requesting device, and the candidate relaying device satisfies one of the following two conditions: a display device with sharing requirements and capable of transmitting at least one set of shared data, or a display device without sharing requirements and supporting simultaneous transmission of multiple sets of shared data.

4. The method of claim 3, wherein the at least one candidate relaying device forms single layer or multiple layers; when the at least one candidate relaying device forms multiple layers, all the candidate relaying devices in a first layer directly receive the shared data transmitted by the main screen device, and the candidate relaying devices in an upper layer of two adjacent layers are capable of transmitting the shared data to corresponding candidate relaying devices in a lower layer;
the selecting of the adapted relaying device from the at least one candidate relaying device based on the second transmission performance information transmitted by the at least one candidate relaying device comprises:
traversing each layer of the at least one candidate relaying device in hierarchical order based on the second transmission performance information transmitted by the at least one candidate relaying device, until the adapted relaying device is selected.

5. The method of claim 4, wherein the traversing each layer of the at least one candidate relaying device in hierarchical order based on the second transmission performance information transmitted by the at least one candidate relaying device comprises:
determining relaying priorities of the candidate relaying devices within a same layer based on the second transmission performance information transmitted by the at least one candidate relaying device; and
selecting the candidate relaying device having the highest relaying priority, among the candidate relaying devices in the same layer, as the adapted relaying device.

6. The method of claim 5, wherein the second transmission performance information includes at least one of gateway information, relayed amount, and remaining relaying amount of the candidate relaying device; and
wherein the relayed amount indicates amount of the shared data currently relayed by the candidate relaying device; and the remaining relaying amount indicates the amount of the shared data that the candidate relaying device can continue relaying.

7. The method of claim 6, wherein when determining the relaying priorities based on the gateway information, the relaying priority of the candidate relaying device in a same LAN as the target requesting device is higher than the relaying priority of the candidate relaying device in a different LAN from the target requesting device;
and/or, when determining the relaying priorities based on the relayed amount, the relaying priority of the candidate relaying device having the relayed amount of zero is higher than the relaying priority of the candidate relaying device having the relayed amount greater than zero;
and/or, when determining the relaying priorities based on the remaining relaying amount, the relaying priority of the candidate relaying device having a larger remaining relaying amount is higher than the relaying priority of the candidate relaying device having a smaller remaining relaying amount.

8. The method of claim 1, further comprising:
transmitting notification information to the target requesting device, wherein the notification information is configured to enable the target requesting device to establish a transmission channel with the adapted relaying device, such that the adapted relaying device forwards the shared data to the target requesting device through the transmission channel.

9. The method of claim 1, further comprising: when a transmission channel between the target requesting device and the adapted relaying device is disconnected, obtaining a new sharing instruction, and generating new shared data based on the new sharing instruction; obtaining new first transmission performance information of the main screen device, and determining whether relaying is required based on the new first transmission performance information of the main screen device; and in response to determining that the relaying is required, transmitting the new sharing instruction to a new adapted relaying device, such that the target requesting device is capable of receiving the new shared data via a relaying operation performed by the new adapted relaying device.

10. A method for data transmission used in a target requesting device, wherein the target requesting device is one of a plurality of display devices, and data is mutually transmitted between a main screen device and the plurality of display devices, as well as among the plurality of display devices through a Personal Area Network (PAN) or a Local Area Network (LAN); and the method comprises:
transmitting a sharing instruction to the main screen device; wherein the sharing instruction is for enabling the main screen device to generate shared data and transmit the shared data or select an adapted relaying device to forward the shared data; and wherein the adapted relaying device is one of the plurality of display devices other than the target requesting device.

11. The method of claim 10, further comprising:
receiving notification information transmitted by the main screen device when selecting the adapted relaying device to forward the shared data; and
establishing a transmission channel with the adapted relaying device based on the notification information, and receiving the shared data relayed by the adapted relaying device through the transmission channel.

12. An electronic device, comprising:
a processor; and
a memory storing a computer program executable by the processor,
wherein the computer program, when executed by the processor, causes the electronic device to perform the method for data transmission used in a main screen device, wherein data can be mutually transmitted between the main screen device and a plurality of display devices, as well as among the plurality of display devices through a Personal Area Network (PAN) or a Local Area Network (LAN), the method comprising:
receiving a sharing instruction and generating shared data based on the sharing instruction;
obtaining first transmission performance information of the main screen device and determining whether relaying is required based on the first transmission performance information of the main screen device; and
in response to determining that relaying is required, transmitting the shared data to an adapted relaying device, such that a target requesting device is capable of receiving the shared data via a relaying operation performed by the adapted relaying device,
wherein the target requesting device is one of the plurality of display devices, which is associated with a sharing requirement; the adapted relaying device is one of the plurality of display devices other than the target requesting device.

13. The electronic device of claim 12, wherein the first transmission performance information includes current load capacity and standard load capacity of the main screen device; the current load capacity indicates amount of the shared data currently being transmitted by the main screen device;
the obtaining of the first transmission performance information of the main screen device and determining whether relaying is required based on the first transmission performance information of the main screen device comprise:
obtaining the current load capacity and the standard load capacity of the main screen device;
in response to determining that the current load capacity is less than the standard load capacity, determining that relaying is not required; and
in response to determining that the current load capacity is equal to the standard load capacity, determining that relaying is required.

14. The electronic device of claim 12, wherein the method further comprises:
obtaining second transmission performance information transmitted by at least one candidate relaying device, and selecting the adapted relaying device from the at least one candidate relaying device based on the second transmission performance information transmitted by the at least one candidate relaying device,
wherein the candidate relaying device is one of the plurality of display devices other than the target requesting device, and the candidate relaying device satisfies one of the following two conditions: a display device with sharing requirements and capable of transmitting at least one set of shared data, or a display device without sharing requirements and supporting simultaneous transmission of multiple sets of shared data.

15. The electronic device of claim 14, wherein the at least one candidate relaying device forms single layer or multiple layers; when the at least one candidate relaying device forms multiple layers, all the candidate relaying devices in a first layer directly receive the shared data transmitted by the main screen device, and the candidate relaying devices in an upper layer of two adjacent layers are capable of transmitting the shared data to corresponding candidate relaying devices in a lower layer; and
the selecting of the adapted relaying device from the at least one candidate relaying device based on the second transmission performance information transmitted by the at least one candidate relaying device comprises:
traversing each layer of the at least one candidate relaying device in hierarchical order based on the second transmission performance information transmitted by the at least one candidate relaying device, until the adapted relaying device is selected.

16. The electronic device of claim 15, wherein the traversing each layer of the at least one candidate relaying device in hierarchical order based on the second transmission performance information transmitted by the at least one candidate relaying device comprises:
determining relaying priorities of the candidate relaying devices within a same layer based on the second transmission performance information transmitted by the at least one candidate relaying device; and
selecting the candidate relaying device having the highest relaying priority, among the candidate relaying devices in the same layer, as the adapted relaying device.

17. The electronic device of claim 16, wherein the second transmission performance information includes at least one of gateway information, relayed amount, and remaining relaying amount of the candidate relaying device; and
wherein the relayed amount indicates amount of the shared data currently relayed by the candidate relaying device; and the remaining relaying amount indicates the amount of the shared data that the candidate relaying device can continue relaying.

18. The electronic device of claim 17, wherein when determining the relaying priorities based on the gateway information, the relaying priority of the candidate relaying device in a same LAN as the target requesting device is higher than the relaying priority of the candidate relaying device in a different LAN from the target requesting device;
and/or, when determining the relaying priorities based on the relayed amount, the relaying priority of the candidate relaying device having the relayed amount of zero is higher than the relaying priority of the candidate relaying device having the relayed amount greater than zero;
and/or, when determining the relaying priorities based on the remaining relaying amount, the relaying priority of the candidate relaying device having a larger remaining relaying amount is higher than the relaying priority of the candidate relaying device having a smaller remaining relaying amount.

19. The electronic device of claim 12, wherein the method further comprises:
transmitting notification information to the target requesting device, wherein the notification information is configured to enable the target requesting device to establish a transmission channel with the adapted relaying device, such that the adapted relaying device forwards the shared data to the target requesting device through the transmission channel.

20. A non-transitory computer-readable storage medium storing a computer program, wherein the computer program, when executed by a processor, causes the method of claim 1 to be performed.
